(19) United States
(12) Patent Application Publication
(10) Pub. No.: US 2020/0086978 A1
(43) Pub. Date: Mar. 19, 2020

(54) AIRCRAFT STABILIZATION SYSTEM

(71) Applicant: SANDEEP KUMAR CHINTALA, LONDON (GB)

(72) Inventors: SANDEEP KUMAR CHINTALA, LONDON (GB); SRIRANJAN RASAKATLA, SHAMSHABAD HYDERABAD (IN)

(21) Appl. No.: 16/493,856

(22) PCT Filed: Mar. 13, 2018
(86) PCT No.: PCT/GB2018/050630

§ 371 Date: Sep. 13, 2019

(30) Foreign Application Priority Data
Mar. 13, 2017 (IN) 201741008603

(51) Int. Cl. B64C 17/00; F16F 15/00; B64D 43/00

(52) U.S. Cl. CPC B64C 17/00; B64D 9/00; B64D 43/00; F16F 15/002

(57) ABSTRACT

The present subject matter relates to an aircraft stabilization system (200). The aircraft stabilization system (200), amongst other components, may include multiple sensors (202), a processing unit (206), and multiple stabilization units (208). The sensors (202) provides sensor data (204). The sensor data (204) is received by the processing unit (206) which may calculate aircraft stabilization parameters based on the sensor data (204). The stabilization units (208) may generate signals based on the aircraft stabilization parameters. The generated signals may be sent to one more stabilization units (208) which may include at least one microcontroller and at least one actuator such as servo motors, hydraulic locks, inflatable rafts, and the like. The actuators, upon receiving the generated signals, operates to counteract tilt caused from maneuvering or vibrations caused due to turbulence.

### TECHNICAL FIELD

The present subject matter relates, in general, to stabilization systems and, in particular, to aircraft stabilization systems.

### BACKGROUND

A payload, such as passengers, cargo, of an aircraft is subjected to, tilt, vibrations, etc., while the aircraft is either taking off, landing, or in a flight. Further, during the flight, the aircraft may experience roll, pitch, and yaw movements, thereby causing damage to the payload or unsettling the payload while in flight. In some cases, excessive movement of the aircraft may displace the cargo inside the aircraft.

### BRIEF DESCRIPTION OF THE DRAWINGS

The detailed description is described with reference to the accompanying figures. In the figures, the left-most digit of a reference number identifies the figure in which the reference number first appears. The same numbers are used throughout the figures to reference the same elements.

FIG. 1 illustrates an aircraft with a detachable cabin module, in accordance with an example implementation of the present subject matter;

FIG. 2 illustrates various components of an aircraft stabilization system, in accordance with an example implementation of the present subject matter;

FIG. 3 illustrates a top view of the cabin module detachably attached to an aircraft frame, in accordance with an example implementation of the present subject matter;

FIG. 4 illustrates a method for aircraft stabilization, in accordance with an example implementation of the present subject matter;

### DETAILED DESCRIPTION

Generally, to provide stabilization to aircrafts against tilt and vibrations during taxiing and/or flight, variety of stabilization devices, such as shock absorbers and anti-vibration padding, are used. However, such stabilization devices provide stabilization to payload of the aircraft, like seats for passengers, payload holding units, etc., but not to complete aircraft. Other stabilization devices that uses Inertial Measurement Unit (IMU), gyroscope, and accelerometers along with gimbals may be used to stabilize different payload of the aircraft. However, use of stabilization devices for each payload of the aircraft consumes considerable space in the aircraft affecting the payload carrying capacity of the aircraft. In addition, the weight of the aircraft also increases thereby resulting in increased consumption of fuel during flight, thereby increasing cost of operating the aircraft.

According to an example implementation of the present subject matter, an aircraft stabilization system to stabilize the aircraft against disturbances like vibrations, shocks, tilts, etc., is described. In an example implementation, the aircraft stabilization system, amongst other components, may include multiple sensors, a processing unit, and multiple stabilization units. In an example implementation, the aircraft may include a modular cabin module for a payload such as passengers, cargo, and other components, and the aircraft stabilization system may be coupled to the modular cabin module to stabilize the cabin module of the aircraft.

In an example implementation of the present subject matter, the sensors may include IMUs, Altitude and Heading Referencing System (AHRS), radar sensor, barometer, laser sensor, proximity sensors, accelerators, motion sensors, gyro sensors, and the like. The sensors may monitor flight parameters of the aircraft during operation of the aircraft. In an example, the flight parameters may comprise flight dynamics data, such as roll, pitch, and yaw angles of the aircraft, altitude and velocity of the aircraft, temperature outside and inside the aircraft, and the like. Further, based on the monitored flight parameters, the sensors may provide sensor data that is indicative of the flight parameters during operation of the aircraft.

As described earlier, the aircraft stabilization system may also include the processing unit. The processing unit receives the sensor data from the sensors to compute stabilization parameters for the aircraft. In an example, the aircraft stabilization parameters may include one of more counteracting angles, rotational speeds, and forces to stabilize the cabin module of the aircraft. In an example implementation, a stabilization unit may include at least one microprocessor and at least one actuator such as servo motors, hydraulic locks, parachutes, hydraulic stands, inflatable rafts, or the like. For stabilization of the cabin module, a stabilization unit receives at least one aircraft stabilization parameter and accordingly, the stabilization unit operates to counter the effects of vibrations tilts, etc., to stabilize the cabin module. In an example implementation, a stabilization unit based on the at least one aircraft stabilization parameter generates pulse width modulated signals which are transmitted to the at least one actuator to stabilize the cabin module. Since whole cabin module of the aircraft is stabilized by the aircraft stabilization system, need for individual stabilization components is eliminated thereby reducing manufacturing cost and weight of the aircraft. The stabilization of the cabin module stabilizes the payload, which may be fragile, such as passengers and cargo, for safe transportation.

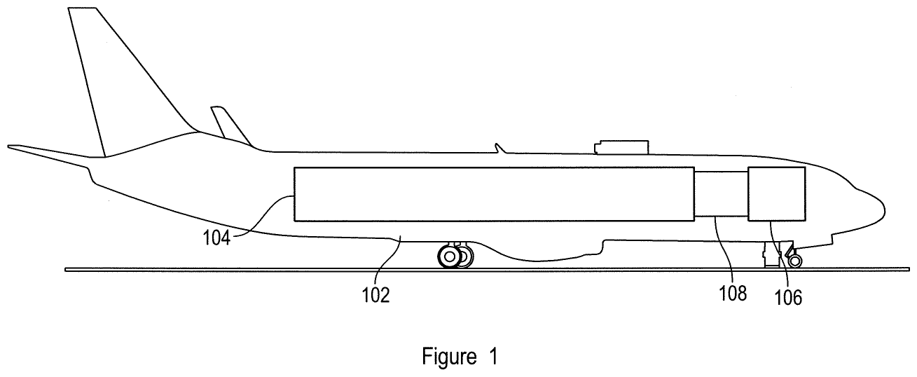

The aircraft stabilization system is further described with reference to FIG. 1 to FIG. 4. It should be noted that the description and the figures merely illustrate the principles of the present subject matter along with examples described herein and, should not be construed as a limitation to the present subject matter. It is thus understood that various arrangements may be devised that, although not explicitly described or shown herein, embody the principles of the present subject matter. Moreover, all statements herein reciting principles, aspects, and implementations of the present subject matter, as well as specific examples thereof, are intended to encompass equivalents thereof.

FIG. 1 illustrates an aircraft 102 comprising a cabin module 104, a crew cabin 106, and a bridge 108 connecting the cabin module 104 to the crew cabin 106. Further, it would be appreciated that the aircraft 102 may also include other modules, such as landing module, propulsion module, which are not shown in FIG. 1, that are used in operation of the aircraft 102. In an example, the aircraft 102 may be a space launch vehicle for launching a payload, such as satellites and space probes, into an outer space. In another example, the aircraft 102 may be used to carry a fragile payload such as passengers and cargo from one location to another location. In one example, the cabin module 104 is secured inside the aircraft 102 such that sufficient cabin space is provided for the payload inside the cabin module 104. In an example implementation, the cabin module 104 may be detachable from the aircraft 102. Therefore, a payload such as passengers, luggage or freight can be easily transferred to the cabin module 104 independently of the aircraft 102. The cabin module may be housed inside a fuselage portion of the aircraft 102. In an example, the cabin module 104 may be installed inside the aircraft with the help of hydraulic locks. In another example, the cabin module 104 can be uninstalled from the hydraulic locks and, may be integrated in a transport vehicle, before being transported to the aircraft 102.

In an example implementation, the cabin module 104 may be installed in a flying car for carrying the payload, which may be fragile. In another example, the cabin module 104 may be installed for carrying the payload, such as passengers and cargo, in an unmanned air vehicle (UAV), such as a drone. In yet another example implementation, the cabin module 104 may be utilized for carrying a payload, such as satellites, space probes, robots, in a spaceship, a space exploration vehicle, and the like.

In an example implementation, the cabin module 104 is automatically detachable from the aircraft 102 in case of an emergency situation, such as engine failure. In the example implementation, the cabin module 104 may be released from the aircraft 102 through a lower panel door (not shown in FIG. I), in case of an emergency situation. In an example, the actuators such as inflatable rafts, parachutes, and hydraulic stands may be coupled to an outer surface of the cabin module 104 to ensure safe landing in emergency situations.

In an example implementation, an aircraft stabilization system (not shown in FIG. 1) may be directly coupled to the cabin module 104 of the aircraft 102 to stabilize the cabin module 104 against vibrations, tilts, shocks, etc., which are experienced by the aircraft 102 during takeoff, landing, and in-flight. The aircraft stabilization system may include a plurality of sensors, a processing unit, and a plurality of stabilization units. In operation, the plurality of sensors monitors flight parameters during takeoff, landing, and in-flight and provides sensor data which is indicative of the flight parameters. The flight parameters monitored by the plurality of sensors is transmitted to the processing unit which computes aircraft stabilization parameters including at least one of counteracting angles, rotational speeds, and forces to stabilize the cabin module. Thereafter, the aircraft stabilization parameters are transmitted to the plurality of stabilization units which stabilizes the cabin module from vibrations, jerks, tilts, etc. based on the aircraft stabilization parameters.

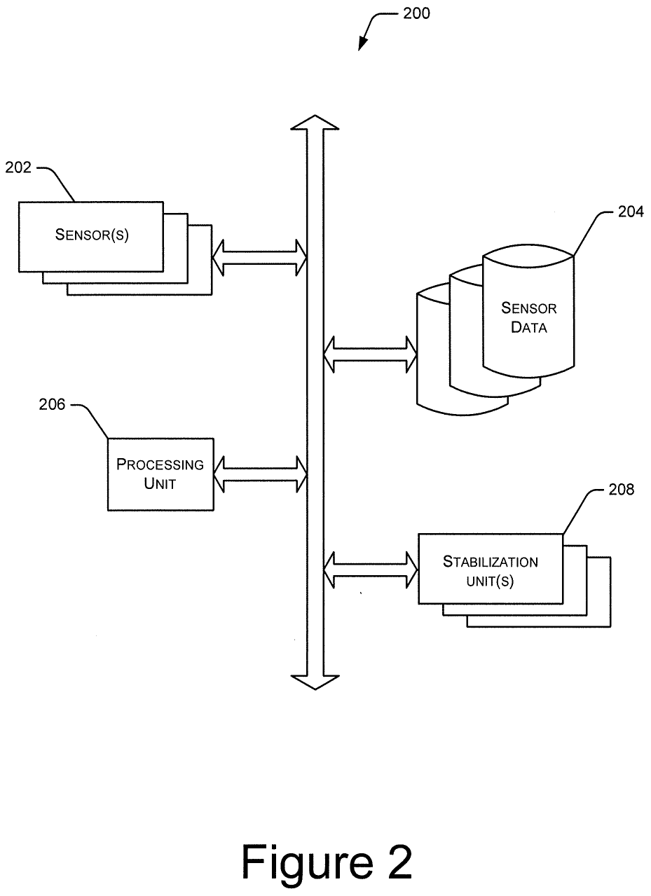

FIG. 2 illustrates components of the aircraft stabilization system 200, in accordance with an example implementation of the present subject matter. The aircraft stabilization system 200 may include a plurality of sensors 202 which may monitor flight parameters to provide sensor data 204. In addition, the aircraft stabilization system 200 may include a processing unit 206 and a plurality of stabilization units 208. In an example, the aircraft stabilization system 200 may be coupled to the cabin module 104 of the aircraft 102. In an example implementation, the plurality of sensors 202 may include sensors such as IMU, AHRS, radar sensor, laser sensor, proximity sensors, motion sensors, gyro sensors, and the like. Further, as described earlier, the flight parameters monitored by the plurality of sensors 202 may include flight dynamics data, roll, pitch, and yaw angles of the aircraft, altitude and velocity of the aircraft, temperature outside and inside the aircraft, and the like. The plurality of sensors 202 may further provide sensor data based on the monitored flight parameters, where the sensor data is indicative of the flight parameters during operation of the aircraft 102

In an example implementation, the processing unit 206 may compute aircraft stabilization parameters based on the sensor data 204 for stabilizing the cabin module 104 of the aircraft 102. Further, in an example, each of the plurality of stabilization units 208 may also include at least one actuator such as high speed brushless servo motors, hydraulic locks, inflatable rafts, hydraulic stands (not shown in FIG. 2). In an example, the at least one microprocessor of each stabilization unit may further include a proportional-integral-differentiator (PID) co-processor. In an example, the plurality of stabilization units 208 are directly coupled to the cabin module 104 of the aircraft 102.

In operation, the plurality of sensors 202 monitors flight parameters and provides sensor data 204 to the processing unit 206. The processing unit 206 upon receiving the sensor data 204, computes aircraft stabilization parameters which may include at least one of counteracting angles, speed, and forces. The aircraft stabilization parameters may then be transmitted to each of the plurality of stabilization units 208.

Further, based on the received aircraft stabilization parameters, a microprocessor of each stabilization unit may generate a pulse width modulated signal for the actuator of the stabilization unit, where the pulse width modulated signal may include one or more of counteracting angles, speed, and forces for the actuator. Further, in an example implementation, a PID co-processor of each stabilization unit may regulate the pulse width modulated signal to provide corrected pulse width modulated signals. In an example implementation, the corrected pulse width modulated signals are calculated by the PID co-processor based on at least one aircraft stabilization parameter and an error due to at least one of aircraft turbulence and rapid change in the flight parameters. In the example implementation, the PID co-processor provides corrected signals to the actuators, taking into consideration the error due to aircraft turbulence, to achieve desired counteracting angles and rotational speeds to stabilize the cabin module 104.

Further, the corrected pulse width modulated signals may include at least one of corrected counteracting angles, counteracting rotation speeds, and counteracting forces to mitigate the effects of tilt, turbulence, and vibrations.

Further, the corrected signals are transmitted to the actuator of each stabilization unit. As explained earlier, the plurality of stabilization units 208 is directly coupled to the cabin module 104 of the aircraft 102. Therefore, the actuators of the plurality of stabilization units 208 upon receiving the corrected signals operate to counteract tilt, jerks, and vibrations caused from maneuvering or turbulence and, thereby stabilizes the cabin module 104 of the aircraft 102.

In an example scenario, when the aircraft 102 is tilted during flight or when the aircraft 102 is taxiing to a runway, the plurality of sensors 202 such as the IMU and gyro sensor may determine roll, pitch, and yaw angles of the aircraft to provide sensor data 204. Thereafter, the sensor data 204 is transmitted to the processing unit 206, which may further determine aircraft stabilization parameters to stabilize the cabin module 104 of the aircraft 102. The aircraft stabilization parameters may contain counteracting angles for different actuators of the plurality of stabilization units 208. The aircraft stabilization parameters are then transmitted to the plurality of stabilization units 208, which upon receiving the aircraft stabilization parameters, operate actuators such as servo motors to stabilize the cabin module 104 with counteracting angles.

In an example implementation, the sensor data 204 received by the processing unit 206 may further include an emergency signal, such as fire in an engine of the aircraft. Upon receiving the emergency signal, the aircraft stabilization system 200 with the help of the plurality of stabilization units 208 may unlock actuators such as hydraulic locks to detach the cabin module 104 from a frame of the aircraft 102. In addition, the plurality of stabilization units 208 may deploy a plurality of parachutes if the cabin module 104 is detached during flight. The parachutes help the cabin module 104 to slowly descend and further, depending upon a landing surface, a combination of other actuators such as hydraulic stands may be activated by the plurality of stabilization units 208 for safe landing of the cabin module 104.

In an example, a set of inflatable rafts attached to an outer surface of the cabin module 104 may be inflated if the cabin module 104 lands on a water body. In the example, the inflatable rafts may be inflated by nitrogen gas generated from Sodium azide present in them. In operation, when the cabin module 104 hits any obstacle during landing, sensors located on the cabin module 104 sends an electronic signal, which detonates the Sodium azide present in the inflatable rafts, and thus, nitrogen gas is released which inflates the rafts. The inflatable rafts act as shock absorbers and helps in safe landing of the cabin module 104 after being detached from the aircraft 102.

In an example implementation, a GPS sensor may also be installed on the cabin module 104. In the example implementation, the GPS sensor may be connected to a satellite and may be used for GPS tracking the position of the cabin module 104. In an example, radio transmitters may be used to send an SOS message from the cabin module 104. In another example, MORSE code transmitters may be used to send the SOS message.

In an example implementation, the aircraft stabilization system may be attached to a cabin module of a flying car for stabilizing the cabin module carrying payload, such as passengers, against tilt, jerks, and vibrations caused due to maneuvering or turbulence. In another example implementation, the aircraft stabilization system may be attached to a cabin module of a UAV, such as a drone, and stabilizes the payload, which may be fragile, carried by the cabin module of the UAV. In yet another example implementation, the aircraft stabilization system may be coupled to a cabin module of a spaceship, a space exploration vehicle, etc., and stabilizes the payload such as satellites, space probes, robots, and the like, against tilt, jerks, and vibrations caused due to maneuvering or turbulence. Thus, the aircraft stabilization system allows safe transportation of fragile payloads, such as passengers, cargos, satellites, space probes, and the like.

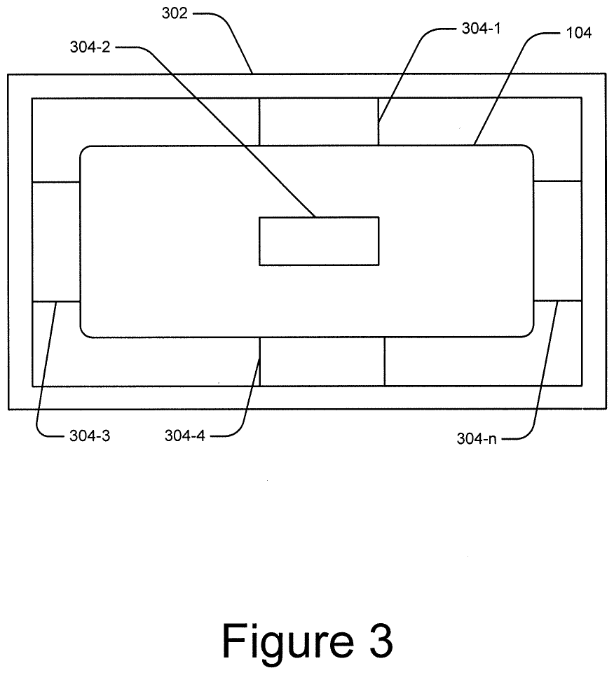

FIG. 3 illustrates the cabin module 104 attached to a frame 302 of the aircraft 102, in accordance with an example implementation of the present subject matter. FIG. 3 depicts a top view of the cabin module 104 being attached to the frame 302 through a plurality of stabilization units 304-1, 304-2, 304-3, 304-4, . . . , 304-n, which are a part of the aircraft stabilization system 200.

Though not shown in FIG. 3, other components of the aircraft stabilization system 200 may also be directly coupled to the cabin module 104. Further, as described earlier, each stabilization unit 304-1, 304-2, 304-3, 304-4, . . . , 304-n may include at least one microprocessor and at least one actuator such as high-speed servo motors, hydraulic locks, parachutes, hydraulic stands, inflatable rafts, and the like. In addition, each stabilization unit 304-1, 304-2, 304-3, 304-4, . . . , 304-n may further include speed controllers for the actuator such as high-speed servo motors.

As explained earlier, the plurality of sensors 202 may monitor flight parameters and provides sensor data 204 which is utilized by the processing unit 206 to compute aircraft stabilization parameters which may include at least one of counteracting angles, speed, and forces. The aircraft stabilization parameters may be further utilized by each stabilization unit 304-1, 304-2, 304-3, 304-4, . . . , 304-n to stabilize the cabin module 104 against tilt, jerks, and vibrations caused due to maneuvering or turbulence.

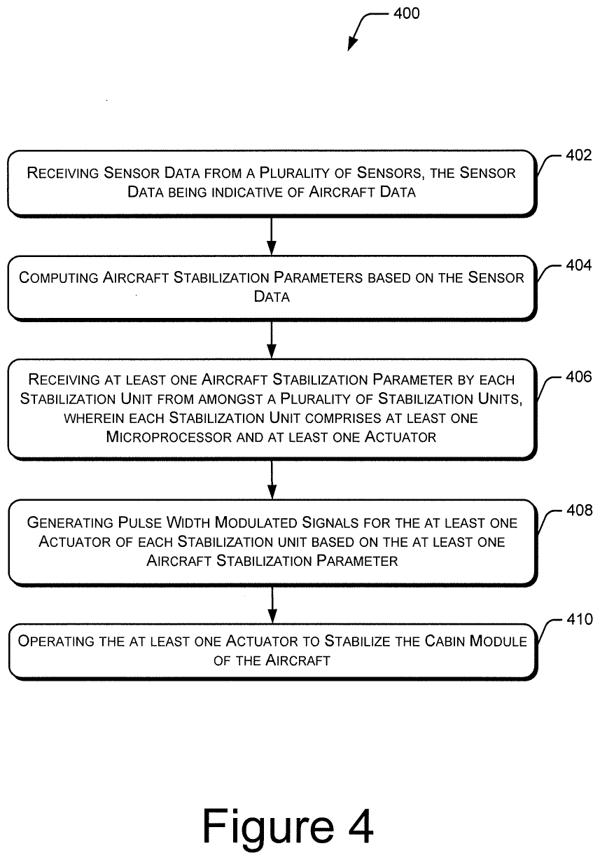

FIG. 4 illustrates a method 400 of aircraft stabilization, in accordance with an example implementation of the present subject matter. At block 402, sensor data 204 is received from a plurality of sensors 202. In an example, the sensor data 204 may be indicative of flight parameters comprising flight dynamics data such as roll, pitch, and yaw angles of the aircraft, altitude and velocity of the aircraft, aircraft proximity data, and the like.

Further, at block 404, aircraft stabilization parameters are computed based on the sensor data 204. In an example implementation, the aircraft stabilization parameters may be computed by the processing unit 206 based on the sensor data 204. In an example, the aircraft stabilization parameters may include at least one of counteracting angles, rotational speeds, and forces for mitigating the tilt or vibrations experienced by the cabin module 104 of the aircraft 102.

Further, at block 406, at least one aircraft stabilization parameter is received by each stabilization unit for stabilizing the cabin module 104. In an example, each stabilization unit may include at least one microprocessor and at least one actuator.

Thereafter, at block 408, pulse width modulated signals are generated for at least one actuator of each stabilization units 208 based on the at least one aircraft stabilization parameter. In an example implementation, the pulse width modulated signals are generated by each of the plurality of stabilization units 208.

Thereafter, at block 410 the at least one actuator of the stabilization unit is operated to stabilize the cabin module 104. Upon receiving the signals, the actuators are operated to mitigate roll, pitch, and yaw movements of the aircraft.

Thereby, stabilizing the aircraft against tilt and vibrations due to turbulence and other external factors.

Although implementations of the aircraft stabilization system as per the present subject matter have been described in a language specific to structural features and/or applications, it is to be understood that the present subject matter is not limited to the specific features or applications described. Rather, the specific features and applications are disclosed as exemplary implementations.

I/we claim:

1. An aircraft stabilization system (200) comprising:
a plurality of sensors (202) to determine sensor data (204), wherein the sensor data (204) is indicative of flight parameters;
a processing unit (206) to receive the sensor data (204), wherein the processing unit (206) computes aircraft stabilization parameters based on the sensor data (204); and
a plurality of stabilization units (208) coupled to a cabin module (104) of an aircraft (102), wherein each stabilization unit from amongst the plurality of stabilization units (208) receives at least one aircraft stabilization parameter and stabilizes the cabin module (104) of the aircraft (102).

2. The aircraft stabilization system (200) as claimed in claim 1, wherein the plurality of sensors (202) comprises at least one of Inertial Measurement Units (IMUs), Altitude and Heading Referencing System (AHRS), radar sensor, barometer, laser sensor, proximity sensors, accelerators, motion sensors, and gyro sensors.

3. The aircraft stabilization system (200) as claimed in claim 1, wherein the flight parameters comprises flight dynamics data including roll, pitch, and yaw angles of the aircraft, altitude and velocity of the aircraft, temperature outside and inside the aircraft (102).

4. The aircraft stabilization system (200) as claimed in claim 1, wherein the aircraft stabilization parameters include at least one of counteracting angles, rotational speeds, and forces.

5. The aircraft stabilization system (200) as claimed in claim 1, wherein each stabilization unit from amongst the plurality of stabilization units (208) comprises at least one microprocessor and at least one actuator.

6. The aircraft stabilization system (200) as claimed in claim 4, wherein the at least one actuator is one of a servo motor, a hydraulic lock, a parachute, a hydraulic stand, and an inflatable raft.

7. The aircraft stabilization system (200) as claimed in claim 5, wherein the at least one processor of a stabilization unit generates pulse width modulated signals for the at least one actuator of the stabilization unit based on the at least one aircraft stabilization parameter, and wherein the pulse width modulated signals are transmitted to the at least one actuator to stabilize the cabin module (104) of the aircraft (102).

8. The aircraft stabilization system (200) as claimed in claim 5, wherein each stabilization unit from among the plurality of stabilization units (208) comprises a proportional-integral-derivative (PID) co-processor.

9. The aircraft stabilization system (200) as claimed in claim 8, wherein the PID co-processor takes into consideration an error due to at least one of aircraft turbulence and rapid change in flight parameters to provide corrected signals to the at least one actuator of each stabilization unit to stabilize the cabin module (104) of the aircraft (102).

10. The aircraft stabilization system (200) as claimed in claim 1, wherein the cabin module (104) is detachable from the aircraft (102).

11. The aircraft stabilization system (200) as claimed in claim 1, the aircraft stabilization system (200) is coupled to one of a flying car, a UAV, a galactic exploration vehicle, a spaceship, a space hovercraft, and the like.

12. A method for stabilizing a cabin module (104) of an aircraft (102), the method comprising:
receiving sensor data (204) from a plurality of sensors (202), the sensor data (204) being indicative of flight parameters;
computing aircraft stabilization parameters based on the sensor data (204);
receiving at least one aircraft stabilization parameter by each stabilization unit from amongst a plurality of stabilization units (208), wherein each stabilization unit comprises at least one microprocessor and at least one actuator;
generating pulse width modulated signals for the at least one actuator of each stabilization unit based on the at least one aircraft stabilization parameter; and
operating the at least one actuator to stabilize the cabin module (104) of the aircraft (102).

13. The method as claimed in claim 12, wherein the aircraft stabilization parameters comprises at least one of counteracting angles, rotational speeds, and forces.

14. The method as claimed in claim 12, wherein the operating the at least one actuator comprises providing corrected signals to the at least one actuator, wherein the corrected signals are provided by a PID co-processor of each stabilization unit.

15. The method as claimed in claim 14, wherein the corrected signals are calculated by the PID co-processor based on the at least one aircraft stabilization parameter and an error due to at least one of aircraft turbulence and rapid change in the flight parameters.

16. The method as claimed in claim 12, wherein the flight parameters comprises flight dynamics data including roll, pitch, and yaw angles of the aircraft, altitude and velocity of the aircraft, temperature outside and inside the aircraft (102).
